(19) United States
(12) Patent Application Publication
(10) Pub. No.: US 2006/0025969 A1
(43) Pub. Date: Feb. 2, 2006

(54) Method for converting a geologic panel into a simulator format

(75) Inventors: Joseph M. Boyles, Fort Collins, CO (US); Ted E. Playton, Austin, TX (US)

Correspondence Address: Richmond, Hitchcock, Fish & Dollar, P.O. Box 2234, Bartlesville, OK, 74005, US

(73) Assignee: ConocoPhillips Company

(21) Appl. No.: 10/909,091

(22) Filed: Jul. 30, 2004

(51) Int. Cl. G06F 15/00

(52) U.S. Cl. 702/189

(57) ABSTRACT

A computer-implemented method of converting a geologic panel into a simulator format is disclosed. A conventional geologic panel is provided in a digital format such that the geologic panel is represented by a plurality of colored pixels. The geologic panel is cleaned such that each pixel represents a subsurface feature by changing pixels not representing subsurface features into pixels representing subsurface features. The geologic panel is also scaled such that each pixel corresponds to a practical dimension. Each pixel within the geologic panel is assigned an identifier corresponding to the pixel's color. The simulator format is created by storing the assigned identifiers in a digital format separate from the geologic panel.

### BACKGROUND OF THE INVENTION

1. Field of the Invention

The present invention relates generally to methods of converting a geologic panel into a computer simulator format. More particularly, the invention relates to a method of converting a geologic panel into a simulator format by providing the geologic panel in a digital format such that the geologic panel is represented by a plurality of colored pixels and then assigning each pixel within the geologic panel an identifier corresponding to the pixel's color.

2. Description of the Prior Art

The use of computer simulations to predict subsurface or subterranean properties is now fundamental in the search for oil and gas reservoirs in the earth. Computer simulations typically utilize geologic data to determine optimal drilling locations based on the simulated flow of hydrocarbons or other elements through the earth. The simulations are additionally utilized for a variety of other purposes, such as predicting rock properties of subsurface features, predicting the future location of subsurface features, etc. Conventional geologic computer simulations, such as those described above, perform calculations and estimations based on a simulator format. The simulator format, which is typically a digital text file including a grid of numerals, is a required element of computer simulations as it indicates the location of detected, estimated, or known subsurface features for a given subsurface area, upon which the simulation is based. Thus, the ability to provide a computer-readable simulator format to a geologic computer simulation is essential to the efficient use of geologic computer simulations.

Unfortunately, conventional methods of providing or producing simulator formats from existing geologic data are extremely complex and have limited the use of the beneficial computer simulations. Simulator formats, as described above, indicate the location of subsurface features of a given subsurface area. The given subsurface area is generally large, such as thousands or millions of square feet, and may include a plurality of important subsurface features each representing an area as small as a few square feet. Thus, simulator formats include a large amount of data which represents a specific location of each feature within the subsurface area. Conventional methods require this large amount of data, which may including thousands or millions of entries, to be manually entered by a user. Such manual input of thousands or millions of entries is obviously undesirable due to time required to input the overwhelming amount of data.

Other conventional methods attempt to avoid this problem by utilizing conventional geologic panels. Conventional geologic panels are commonly utilized to represent subsurface geologic features and are readily available from various sources. However, conventional geologic panels are generally printed or hand-drawn hardcopies which must be converted to the computer-readable simulator format. Conventional methods of converting these hardcopies to the simulator format are complex and also limit the use of computer simulations. For instance, hardcopies of printed or hand-drawn geologic panels are usually converted to a digital format by having a user operate a digitizer to manually identify the borders of each subsurface feature. For instance, auser typically places aprinted geologic panel, which may include hundreds or thousands of subsurface features, on a digitizing table, and then manually identifies the borders of each region. Each region often has a complex and non-uniform border such that the user is required to manually identify the border of each region by selecting tens or hundreds of points for each region. The digitizer then generates a simulator format based on the identified regions. Thus, these other conventional methods are also undesirable due to the time required for a user to input thousands of data points, representing the border of each subsurface region, utilizing a digitizer.

### OBJECTS AND SUMMARY OF THE INVENTION

It is, therefore, an object of the present invention to provide a method for more easily providing a simulator format to a computer simulation.

Another object of the invention is to provide a method of converting a geologic panel into a simulator format without requiring a user to manually input an overwhelming amount of data.

Still another object of the present invention is to provide a method of converting a geologic panel into a simulator format utilizing readily accessible equipment such that use of a digitizer is not required.

A still further object of the present invention is to provide a method of converting a geologic panel into a simulator format utilizing an optically scanned printed or hand-drawn geologic panel.

It should be understood that the above-listed objects need not all be accomplished by the invention claimed herein. Further objects and advantages of the present invention will be apparent from the detailed description of the preferred embodiment, the claims, and the drawing figures.

Accordingly, in one embodiment of the present invention, there is provided a method for converting a geologic panel into a numeric simulator format. The method includes the steps of (a) providing a digital geologic panel in a first digital format such that the geologic panel is represented by a plurality of colored pixels; (b) assigning at least one pixel an identifier corresponding to the pixel's color; and (c) creating the simulator format by storing each assigned identifier in a second digital format separate from the first digital format of the digital geologic panel.

In accordance with another embodiment of the present invention, there is provided a method for converting a geologic panel into a numeric simulator format. The method includes the steps of (a) providing a digital geologic panel in a first digital format such that the geologic panel is represented by plurality of colored pixels; (b) cleaning the digital geologic panel by changing pixels not representing subsurface features into pixels representing subsurface features; (c) scaling the cleaned geologic panel such that each pixel corresponds to a practical dimension; (d) assigning each pixel within the scaled geologic panel a numeric identifier corresponding to the pixel's color; and (e) creating the simulator format by storing the assigned identifiers in a second digital format separate from the first digital format of the digital geologic panel.

In accordance with a further embodiment of the present invention, there is provided a method for converting a crude geologic panel into a numeric simulator format. The method includes the steps of (a) optically scanning a hardcopy of a hand-drawn and/or printed color geologic panel to thereby provide a digital geologic panel comprising a plurality of colored pixels; (b) cleaning the digital geologic panel by changing the color of each pixel not representing a subsurface feature to a color corresponding to a subsurface feature, wherein the color of each pixel is utilized to determine if the pixel represents a subsurface feature and the changed color ofeach pixel not representing subsurface features is determined by a color of a closest pixel representing a subsurface feature; (c) assigning each pixel within the digital geologic panel a numeric identifier corresponding to the pixel's color; and (d) creating the simulator format by storing the assigned identifiers in a text file separate from the geologic panels, wherein the stored identifiers are positioned within a grid corresponding to the position of each pixel.

### BRIEF DESCRIPTION OF THE DRAWING FIGURES

The patent or application file contains at least one drawing executed in color. Copies of this patent or patent application publication with color drawing(s) will be provided by the Office upon request and payment of the necessary fee.

A preferred embodiment of the present invention is described in detail below with reference to the attached drawing figures, wherein:

FIG. 1 is a flow chart outlining the steps for converting a geologic panel into a simulator format in accordance with a preferred embodiment of the present invention;

FIG. 2 is a color drawing of a conventional geologic panel utilized with the preferred embodiment of the present invention;

FIG. 3 is a color drawing of a cleaned geologic panel created by removing and replacing erroneous or extraneous pixels from the conventional geologic panel of FIG. 2;

FIG. 4 is a color drawing of a scaled geologic panel created by scaling each pixel of the cleaned geologic panel of FIG. 3 to a practical dimension;

FIG. 5 is a color drawing of a geologic panel including identifiers, wherein the geologic panel including identifiers is created from the scaled geologic panel of FIG. 4;

FIG. 6 is a numeric simulator format including the identifiers of FIG. 5; and

FIG. 7 is table including subsurface feature data representing rock property information which corresponds to the numeric simulator format of FIG. 6.

### DETAILED DESCRIPTION OF THE PREFERRED EMBODIMENTS

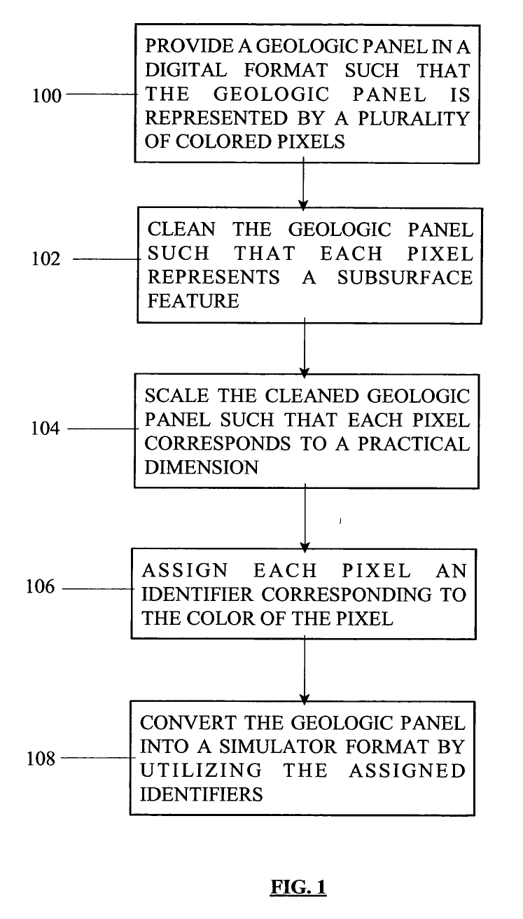

Referring initially to FIG. 1, the present invention involves a computer-implemented method for converting a geologic panel into a simulator format. Steps 100-108 in FIG. 1 outline the inventive computer-implemented conversion scheme. The steps of the inventive method described herein can be programmed and stored on a device readable by a standard computing device, such as a personal computer or computer network. Suitable program storage devices include, for example, CDs, DVDs, internal computer hard drives, and external network hard drives.

In step 100 (FIG. 1), a conventional geologic panel is provided for utilization with the present invention. Specifically, the geologic panel is provided in a digital format such that the geologic panel is represented by a plurality of colored pixels. In a preferred embodiment, the conventional geologic panel is provided by optically scanning a hardcopy of a printed or hand-drawn geologic panel that employs various colors or shades of grey to identify various subsurface properties, features, or formations. The printed or hand-drawn geologic panel may be optically scanned utilizing conventional equipment, such as a scanner, a photocopier, a camera, etc, and then stored in a conventional digital image format. Preferably, the geologic panel is provided and stored in a graphic interchange format (GIF), a joint photographic experts group format (JPEG), a bitmap (BMP), a tagged image file format (TIFF), or other any other conventional digital image format, to enable access of the stored geologic panel by a conventional computing device and conventional image editing software, as discussed in more detail below.

The geologic panel may also be provided in a digital format through a variety of other means. For instance, the geologic panel may be provided by a computer or manual representation of geologic, seismic, or well log data, such as a simulation. Thus, the geologic panel may be provided from actual or estimated geologic information or actual or estimated geologic information provided by the representation, such as an geologic panel artificially generated by a computer. The geologic panel may be also be provided by accessing a remotely or locally stored digital copy of a geologic panel, such as a previously scanned or created digital copy, by creating a geologic panel utilizing computing software, such as drawing a geologic panel using conventional image editing software, or by utilizing a computing device which automatically and simultaneously converts a user's drawings and writings into a digital format.

“Colored pixel”, as used herein, refers to the smallest discrete element of an image. As is known in the art, images stored in conventional digital formats, such as those listed above, are comprised of a plurality of colored pixels. The number of pixels in any given image is determined by the resolution of the image. For instance, images having a greater resolution will have a greater number of pixels per unit of measurement. As is also known in the art, “colored pixel” is not limited to colors having positive amounts of red, green, and blue, but also encompasses black, white, grey, and varying shades thereof.

Referring to FIG. 2, the conventional geologic panel illustrates various subsurface features including limestone regions, non-marine regions, channel sand regions, delta sand regions, shale regions, and/or any other subsurface features. As is known in the art, each subsurface feature in a conventional geologic panel is assigned a unique color. For instance, in FIG. 2, limestone is assigned blue; non-marine is assigned green; channel sand is assigned red; delta sand is assigned yellow; and shale is assigned grey. Portions of the panel not attributed to a specific or desired subsurface feature, such as subsurface areas which are unidentifiable due to measurement errors or areas which are not clearly defined in drafting, are assigned white. Additionally, the geologic panel includes vertical reference lines indicating specific distances across the panel and each region is identified by a text identifier. The geologic panel represents a lateral and vertical subsurface distance and is to scale as indicated by the markings depicted in the lower-left corner of the panel. It will be appreciated that the geologic panel of FIG. 2 is merely an example of a conventional geologic panel, and that any conventional geologic panel, including any combination of subsurface features, colors including grey-scale, markings, identifiers, etc, may be utilized by the present invention.

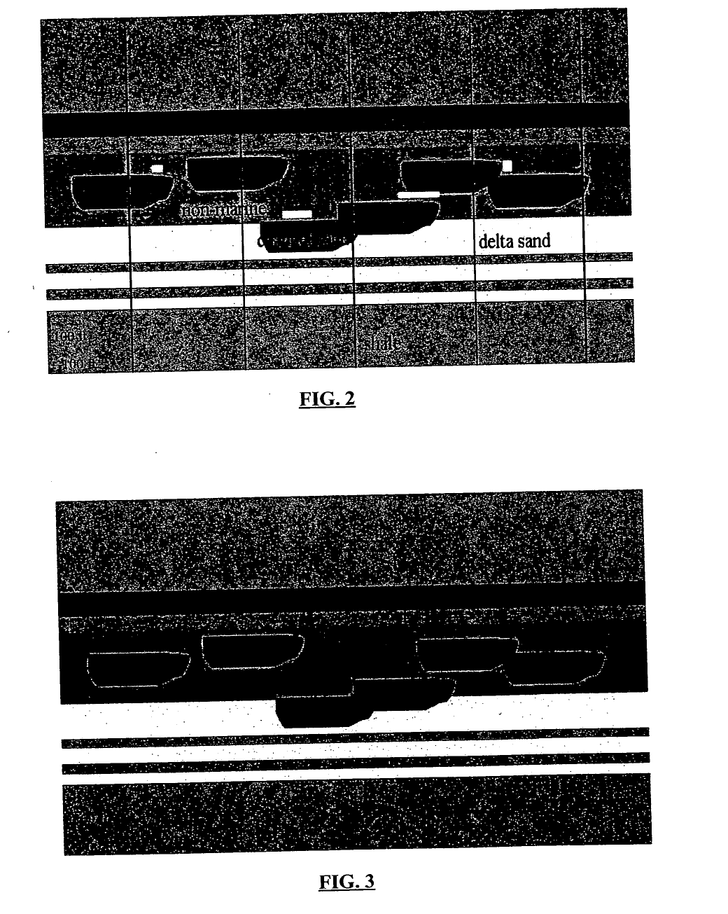

In step 102 (FIG. 1), the digital geologic panel is cleaned such that each pixel present in the panel represents a subsurface feature. Specifically, the digital geologic panel is cleaned such that the cleaned panel only represents subsurface features by changing pixels not representing subsurface features into pixels representing subsurface features. For instance, as illustrated by FIG. 3, unidentifiable regions, text identifiers, vertical reference lines, stray or erroneous markings, etc, are eliminated or “cleaned” from the panel of FIG. 2 to create the cleaned panel of FIG. 3. Thus, each pixel in the cleaned geologic panel of FIG. 3 represents one subsurface geologic feature, such as limestone, non-marine, channel sand, delta sand, shale, etc.

Preferably, the digital geologic panel is cleaned utilizing a conventional computing device and conventional image editing software such as DENEBA CANVAS v8.0 available from ACD SYSTEMS of British Columbia, Canada. The conventional image editing software may utilize various graphic processing functions including vector and raster manipulation, and need not be limited only to the manipulation of pixels. The conventional image editing software is utilized to identify each colored region, which corresponds to a plurality of pixels representing a single subsurface geologic feature, and automatically remove erroneous or extraneous pixels not corresponding to the single subsurface geologic feature. For instance, the green non-marine region of FIG. 2 substantially contains green pixels but includes white pixels forming several white areas which represent erroneous data, as described above. The conventional image editing software identifies the white areas and white pixels within the green non-marine region utilizing auto-tracing or other conventional region identification functions and replaces the white pixels with green pixels. Similarly, other erroneous colors within each region, such as black pixels corresponding to the text identifiers or vertical lines, are replaced with an appropriate color, preferably the dominant color of each region. Thus, the color of each pixel is utilized to determine if the pixel represents a subsurface feature and pixels not representing subsurface features are preferably changed to the color of the closest pixel representing a subsurface feature. For instance, if a single white pixel is within a region of green pixels, such that a majority of pixels surrounding the white pixel are green, the color of the single white pixel is changed to green. This method is repeated for each region such that erroneous or extraneous pixels are removed from each region present in the geologic panel. Additionally, the conventional image editing software may be provided with data indicating acceptable colors for the cleaned geologic panel, such as the blue, green, red, yellow, and grey colors present in FIG. 3, to expedite and facilitate the identification of erroneous and extraneous regions.

In step 104 (FIG. 1), the cleaned geologic panel is scaled such that each pixel corresponds to a practical dimension. For instance, conventional geologic panels generally represent several hundred feet of subsurface lateral measurement and several hundred feet of subsurface vertical measurement. The dimensions that each pixel corresponds to may be determined by dividing the lateral and vertical distance the cleaned geologic panel represents by the number of pixels along the lateral and vertical planes. For example, the cleaned geologic panel of FIG. 3 represents a thousand feet of subsurface lateral measurement and includes 960 lateral pixels. Thus, each pixel present in the cleaned geologic panel of FIG. 3 represents 1.04 horizontal feet. Similarly, the cleaned geologic panel of FIG. 3 represents six-hundred feet of subsurface vertical measurement and includes 660 vertical pixels. Thus, each pixel present in the cleaned geologic panel of FIG. 3 represents 0.91 vertical feet and a total dimension of 1.04 ft.×0.91 ft. The dimension of 1.04 ft,×. 0.91 ft. is not a practical dimension commonly utilized in geologic or seismic analysis. For instance, conventional geologic or seismic analysis generally requires symmetric dimensions, such as 1 ft.×1 ft. or 10 ft.×10 ft.

The conventional image editing software is utilized to scale the cleaned geologic panel such that each pixel represents a practical dimension. Specifically, the desired scaled geologic panel dimensions are provided to conventional image editing software which renders and scales the cleaned geologic panel to the desired dimensions utilizing conventional rendering and scaling algorithms. For instance, if a practical dimension is 10 ft. by 10 ft., and the cleaned geologic panel of FIG. 3 is utilized with 960 horizontal pixels and 660 vertical pixels, the conventional image editing software is provided with a desired scaled horizontal pixel length of 96 pixels and a desired scaled vertical pixel height of 66 pixels, such that each pixel corresponds to 10 ft. by 10 ft, as is illustrated in FIG. 4. The conventional image editing software may be also directly provided with the desired practical dimensions or other related information, such as a desired image size in inches or bytes. Any practical dimension may be utilized by the present invention based on the specific requirements of each geologic panel and accompanying analysis. Thus, in some situations it may be unnecessary to scale the cleaned image.

In step 106 (FIG. 1), each pixel within the scaled geologic panel is assigned an identifier corresponding to the color of the pixel. For instance, pixels having a first color are assigned a first identifier, pixels having a second color are assigned a second identifier, etc. As all erroneous colors and/or regions were removed from the panel in step 102 (FIG. 1), each pixel represents a subsurface geologic feature and thus each identifier represents a subsurface feature.

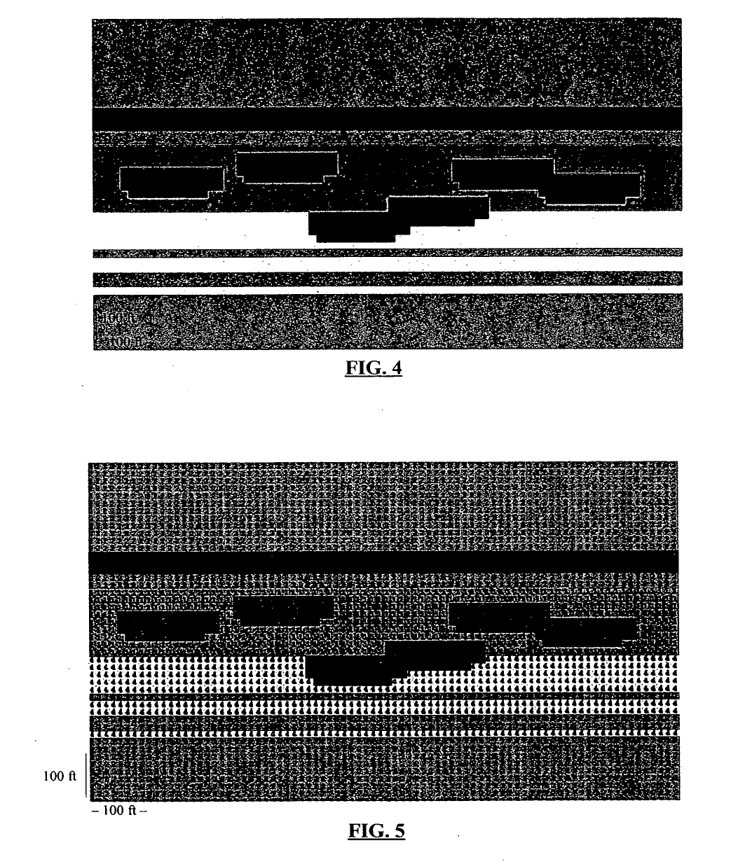

The identifier may be a symbol, letter, number, array of symbols, letters, or numbers, or any combination thereof. Preferably, the identifier is a number such that each subsurface geologic region corresponds to a unique numeral. For example, as shown in FIG. 5, a plurality of green pixels form a green region corresponding to a non-marine feature and each pixel is assigned the number 1, each gray pixel corresponds to a shale feature and is assigned the number 2, each red pixel corresponds to a channel sand feature and is assigned the number 3, each yellow pixel corresponds to a delta sand feature and is assigned the number 4, and each blue pixel corresponds to a limestone feature and is assigned the number 0. Similarly, identifiers would be assigned to other or additional subsurface features not present in the example panel of FIG. 5. Additionally, the identifier may be identical to the data utilized by conventional image formats, such as GIF, JPEG, TIFF, BMP, etc, to represent each pixel within the image format.

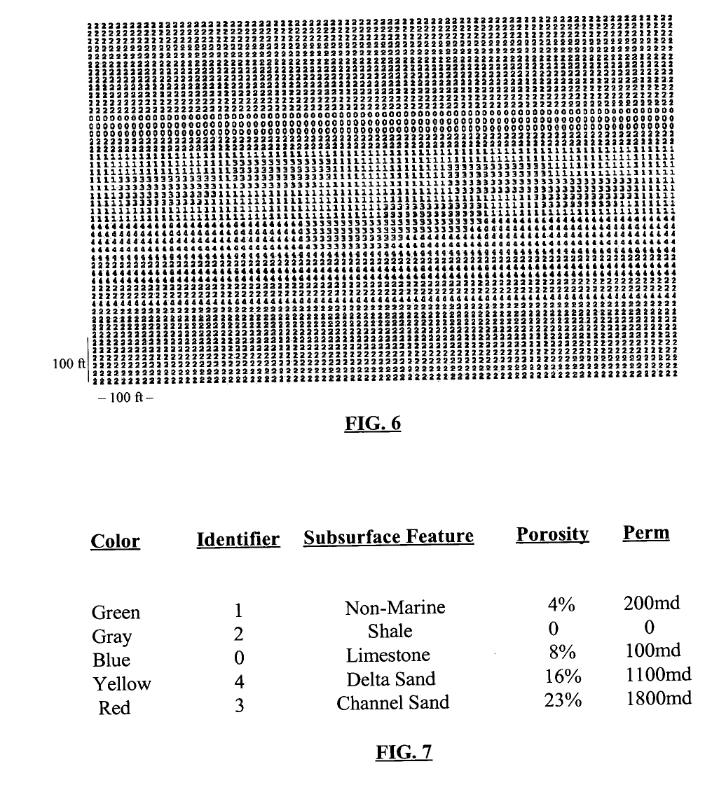

In step 108 (FIG. 1), the scaled geologic panel is converted to a simulator format by utilizing the assigned identifiers. Specifically, the assigned identifiers are separated from the geologic panels to create the simulator format. Preferably, the position of the assigned identifiers within the simulator format corresponds the position of each pixel within the scaled geologic panel. For example, as shown in FIG. 6, the numeric identifiers of FIG. 5 are separated from the scaled geologic panel of FIG. 5 and placed in a grid corresponding to the position of each related pixel within the scaled geologic panel of FIG. 5. Thus, the numeric simulator format preferably comprises a grid of numeric identifiers which represent subsurface geologic formations.

The identifiers are preferably assigned and separated to create a simulator format by utilizing conventional image conversion software such as common GIF to TXT conversion software distributed by vendors such as WPGSOFT of China. The conventional image conversion software utilizes an image file, such as the scaled geologic panel, assigns an identifier to each pixel based on the color of the pixel, as described above, and creates a grid of numbers corresponding to each colored pixel within the image file and stores the grid of numbers in a separate simulator format, such as an ASCII text file (TXT). Similarly, the scaled geologic panel may be converted to a grid, array, table, or other text listing of identifiers through other image conversion software to create a grid, array, table, or other text listing, stored in any digital format utilized by simulation software, having identifiers each corresponding to a subsurface feature. Additionally, the identifiers may be stored within the same computer-readable file as the geologic panel, such as a GIF, to allow the computer-readable file to be utilized as both the simulator format and the digital geologic panel.

Referring to FIG. 7, the numeric simulator format may include, or accompany, subsurface feature data corresponding to each numeral present in the numeric simulator format. For instance, the subsurface feature data illustrated in FIG. 7 accompanies the numeric simulator format of FIG. 6 and provides conventional rock property data for each identifier. The rock property data of FIG. 7 is specifically tailored for seismic analysis, but the subsurface feature data utilized by the present invention may include any data corresponding to the assigned identifiers such that the simulator format and subsurface feature data may be utilized to perform any desired analysis. In as much as the simulator format is in conventional form, by including a plurality of identifiers representing a plurality of subsurface features, analysis performed based on the simulator format is not limited by the scanning, cleaning, scaling, and converting described above.

The preferred forms of the invention described above are to be used as illustration only, and should not be used in a limiting sense to interpret the scope of the present invention. Obvious modifications to the exemplary embodiments, including applying the above-described steps in an alternate order, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A method for converting a geologic panel into a simulator format, the method comprising:
(a) providing a digital geologic panel in a first digital format such that the geologic panel is represented by a plurality of colored pixels;
(b) assigning at least one pixel an identifier corresponding to the pixel's color; and
(c) creating the simulator format by storing each assigned identifier in a second digital format separate from the first digital format of the digital geologic panel.

2. The method of claim 1, wherein the digital geologic panel is provided by optically scanning a hardcopy of a printed or hand-drawn geologic panel.

3. The method of claim 1, wherein the digital geologic panel is provided by a computer representation.

4. The method of claim 1, wherein the digital geologic panel is provided by accessing a stored digital copy of a stored geologic panel.

5. The method of claim 1, further comprising cleaning the digital geologic panel by changing pixels not representing subsurface features into pixels representing subsurface features.

6. The method of claim 5, wherein the color of each pixel is utilized to determine if the pixel represents a subsurface feature.

7. The method of claim 1, further comprising scaling the digital geologic panel such that each pixel corresponds to a practical dimension.

8. The method of claim 1, wherein the assigned identifiers are positioned within the second digital format to correspond to the position of each pixel.

9. The method of claim 1, wherein the simulator format is numeric such that each assigned identifier is a number.

10. The method of claim 1, wherein the first digital format and the second digital format are stored within the same computer-readable file.

11. A method for converting a geologic panel into a numeric simulator format, the method comprising:
(a) providing a digital geologic panel in a first digital format such that the geologic panel is represented by plurality of colored pixels;
(b) cleaning the digital geologic panel by changing pixels not representing subsurface features into pixels representing subsurface features;
(c) scaling the cleaned geologic panel such that each pixel corresponds to a practical dimension;
(d) assigning each pixel within the scaled geologic panel a numeric identifier corresponding to the pixel's color; and
(e) creating the simulator format by storing the assigned identifiers in a second digital format separate from the first digital format of the digital geologic panel.

12. The method of claim 11, wherein the digital geologic panel is provided by optically scanning a hardcopy of a printed or hand-drawn geologic panel.

13. The method of claim 11, wherein the digital geologic panel is provided by a computer representation.

14. The method of claim 11, wherein the geologic panel is provided by accessing a stored digital copy of a stored geologic panel.

15. The method of claim 11, wherein the color of each pixel is utilized to determine if the pixel represents a subsurface feature.

16. The method of claim 11, wherein step (b) includes changing the color of each pixel not representing a subsurface feature to a color corresponding to a subsurface feature.

17. The method of claim 16, wherein the changed color of each pixel not representing a subsurface feature is determined by a color of a closest pixel representing a subsurface feature.

18. The method of claim 11, wherein the practical dimension is at least approximately ten feet by ten feet.

19. The method of claim 11, wherein step (e) includes storing the identifiers in a text file.

20. The method of claim 19, wherein step (e) includes positioning the identifiers within a grid to correspond to the position of each pixel.

21. A method for converting a crude geologic panel into a numeric simulator format, the method comprising:
(a) optically scanning a hardcopy of a hand-drawn and/or printed color geologic panel to thereby provide a digital geologic panel comprising a plurality of colored pixels;
(b) cleaning the digital geologic panel by changing the color of each pixel not representing a subsurface feature to a color corresponding to a subsurface feature, wherein the color of each pixel is utilized to determine if the pixel represents a subsurface feature and the changed color of each pixel not representing subsurface features is determined by a color of a closest pixel representing a subsurface feature;
(c) assigning each pixel within the digital geologic panel a numeric identifier corresponding to the pixel's color; and
(d) creating the simulator format by storing the assigned identifiers in a text file separate from the geologic panels, wherein the stored identifiers are positioned within a grid corresponding to the position of each pixel.

22. The method of claim 21, further comprising scaling the cleaned geologic panel such that each pixel corresponds to a practical dimension.

23. The method of claim 22, wherein the practical dimension is at least approximately ten feet by ten feet.
